(19) United States
(12) Patent Application Publication
(10) Pub. No.: US 2008/0005380 A1
(43) Pub. Date: Jan. 3, 2008

(54) INTEGRATED CONFIGURATION AND MANAGEMENT OF HARDWARE DEVICES

(75) Inventors: Charlie Kawasaki, Portland, OR (US); Jim Barber, Beaverton, OR (US)

Correspondence Address: PERKINS COIE LLP;PATENT-SEA, P.O. BOX 1247, SEATTLE, WA, 98111-1247, US

(73) Assignee: Pacific Star Communications, Inc., Portland, OR (US)

(21) Appl. No.: 11/677,555

(22) Filed: Feb. 21, 2007

Related U.S. Application Data
(63) Continuation-in-part of application No. 11/544,224, filed on Oct. 6, 2006.
(60) Provisional application No. 60/775,315, filed on Feb. 21, 2006.
(60) Provisional application No. 60/775,300, filed on Feb. 21, 2006.
(60) Provisional application No. 60/880,154, filed on Jan. 11, 2007.

(51) Int. Cl. G06F 3/00; G06F 15/16; G06F 17/00

(52) U.S. Cl. 710/15; 707/204; 709/229; 707/E17.005

(57) ABSTRACT

The integrated management system provides a unified interface for common management tasks related to managing interconnected devices, such as in an integrated computer system. First, the integrated management system provides a unified backup and restoration facility for backing up and restoring the configuration of multiple devices through a single user interface presented to the operator. The integrated management system also provides a monitoring facility for monitoring the health of multiple hardware devices in through a single user interface. Finally, the integrated management system makes configuration of multiple devices easier by providing a unified interface for common configuration tasks.

### CROSS-REFERENCE TO RELATED APPLICATIONS

This application is a continuation in part of U.S. patent application Ser. No. 11/544,224 (Attorney Docket No. 56934-8003.US01), entitled “Mobile Broadband Communication Systems, Such as a Deployable Self-Contained Portable System,” filed Oct. 6, 2006, and claims priority to: U.S. Provisional Patent Application No. 60/775,315, entitled “Flexi-Case Assembly,” filed Feb. 21, 2006; U.S. Provisional Patent Application No. 60/775,300, entitled “Wizard-driven Configuration Management Software for Deployable and Mobile Broadband Communications and Data Appliance,” filed Feb. 21, 2006; and to U.S. Provisional Patent Application No. 60/880,154 (Attorney Docket No. 56934-8009.US00), entitled “Intelligent Power Control,” filed Jan. 11, 2007, each of which is hereby incorporated herein by reference.

This application is related to U.S. patent application Attorney Docket No. 56934-8003.US02 entitled “Mobile Broadband Communications System, such as a Deployable Self-Contained Portable System,” which is being filed concurrently and which is hereby incorporated herein by reference.

### BACKGROUND

The hardware and functionality of computers have continuously expanded since the computer's introduction. Early computers were solitary devices that communicated with operators only through switches and printed output. Modern computers may interact with a variety of other devices and interact with operators in a variety of ways. For example, most computers today are attached to monitors, keyboards, mice, printers, scanners, networks, and so on. Many computers are connected to devices almost as complex as the computer itself, many of which include embedded processors and operating software of their own. For example, computers may be connected to other computers, firewalls, phone systems, network switches, wireless access points, uninterruptible power supplies (UPS), storage area networks (SAN), and so forth. Many offices have phone systems, sometimes called private branch exchanges (PBX), which are controlled by computers. A PBX is a manually or automatically operated telephone facility that handles communications within an office, office building, or organization and that is connected to the public telephone network. Devices attached to a computer system may also be provided by many different vendors or manufacturers.

One type of computer system that is increasing in popularity is an integrated computer system that includes one or more computers and one or more additional devices that are tightly coupled, sometimes by including each of the devices within the same case. For example, the above-referenced application entitled “Flexi-Case Assembly,” describes one type of integrated computer system. An integrated computer system may integrate many devices such as a server computer, firewall, PBX, and so on into a single ruggedized case for creating a deployable network that an operator can deploy in a variety of situations. For example, an operator may deploy an integrated computer system on a battlefield to provide communications among soldiers, in an ad hoc medical facility used to provide disaster relief, or in a temporary remote office.

Each of the devices that a computer interacts with has configuration information and management requirements for maintaining the proper operation of the device. For example, a wireless access point may provide a web server that hosts a web page that an operator can view to change configuration settings such as the device's IP address, security parameters, and publicly visible name. A network switch may offer a telnet or secure shell (SSH) interface for viewing and changing settings such as routing information. A firewall may provide a Simple Network Management Protocol (SNMP) interface for modifying open network ports. Other devices may provide a web services interface, such as through the Simple Object Access Protocol (SOAP). Each device may store configuration differently. For example, a device may contain embedded firmware that stores the configuration information for the device. Other devices may contain storage media such as a hard drive, removable storage device, or other storage device for storing configuration information.

With so many devices interacting in a computer system, it becomes difficult for an operator to configure and manage the computer system. For example, if the operator needs to backup the configuration of the devices, the operator has to access each device using one of the interfaces exposed by the device, extract and record the configuration information, and then keep up with the configuration information of each device, which may be in any number of formats. Restoration of the configuration information is similarly difficult and involves locating saved configuration information for each component, communicating the information to the component, and taking steps to restart the system in a way that prepares each device for changes that may have occurred in other, dependent devices. It is also difficult to determine the health, or status, of the system. For example, when a failure occurs it is difficult for an operator to determine which device is the cause of the failure and to verify which setting of the failing device the operator has not correctly configured.

### BRIEF DESCRIPTION OF THE DRAWINGS

FIG. 1 is a block diagram that illustrates components of the integrated management system.

FIG. 2 is a flow diagram that illustrates the processing of the backup component of the integrated management system.

FIG. 3 is a flow diagram that illustrates the processing of the restore component of the integrated management system.

FIG. 4 is a flow diagram that illustrates the processing of the peering component of the integrated management system.

FIG. 5 is a data structure that illustrates the format for storing backup data from multiple devices.

FIGS. 6A-6G illustrate display pages of the user interface of the system for backing up the configuration of multiple devices.

FIGS. 7A-7I illustrate display pages of the user interface of the system for restoring up the configuration of multiple devices.

### DETAILED DESCRIPTION

The headings provided herein are for convenience only and do not necessarily affect the scope or meaning of the claimed invention.

Overview

The following description provides a method and system for integrated configuration and management of computer-based devices, called the integrated management system. The integrated management system provides a unified interface for common management tasks related to managing interconnected devices, such as in an integrated computer system. First, the integrated management system provides a unified backup and restoration facility for backing up and restoring the configuration of multiple devices through a single user interface presented to the operator. The integrated management system also provides a monitoring facility for monitoring the health of multiple hardware devices in through a single user interface. Finally, the integrated management system makes configuration of multiple devices easier by providing a unified interface for common configuration tasks, such as setting the Internet Protocol (IP) address of multiple devices and peering devices together for sharing data. In this way, the integrated management system makes the configuration and management of multiple devices easier and less error-prone, thus freeing operators to perform other tasks such as adding additional functionality to a deployed computer system.

The devices with which the integrated management system interacts may be remote or co-located. For example, a computer may communicate with a network switch that sits next to the computer both of which the integrated management system manages. In addition, the computer may interact with a network switch that is located many miles away, but that is nevertheless accessible through a connection to the computer, such as over the Internet. The integrated management system may provide for unified configuration and management of many devices regardless of the location of the devices.

In some embodiments, the integrated management system operates on non-physical devices. For example, the integrated management system may treat a software module as a virtual device for the purposes of backing up and restoring the module's configuration. As another example, the integrated management system may treat an application, such as software for accelerating communications over a satellite, as a virtual device for backing up, restoring, checking status, performing configuration, and other types of operations. In addition, sub-modules of a device, whether it is hardware or software, physical or virtual, may be treated as devices unto themselves by the integrated management system. In some embodiments, an operator can configure how various components of the integrated management system are divided into devices that are managed by the system.

In some embodiments, the integrated management system provides security roles that determine which actions a particular operator can perform. For example, the integrated management system may provide roles such as operator, field operator, and depot administrator. Some roles may not be able to perform some actions. For example, an operator may not be able to exit a unified user interface application to perform lower level operating system functions or run other applications. The integrated management system may implement security roles through underlying operating system functionality such as the Microsoft Windows Active Directory and Group Policy Objects. When adding new users to the system, the integrated management system may perform different steps for each device attached to the system. For example, the integrated management system may create a new user entry in the Microsoft Windows Active Directory, provide the user with a phone extension through an attached PBX, and create shared network folders for storing data, and so on.

In some embodiments, the integrated management system contains an abstraction layer for isolating higher-level functions of the integrated management system from the underlying communication protocols used to communicate with various devices. For example, when adding a new user, the higher level of the integrated management system may invoke an add user function for each device, and the abstraction layer then communicates with each device using the preferred protocol for the device to add the user. The preferred protocol can be telnet, SSH, SOAP, SNMP, file transfer protocol (FTP), WMI, TCP, COM, or any number of common communication protocols for accessing devices. Some devices may only provide a web page for communicating with the device, and the integrated management system may interact with such devices by submitting and receiving information to and from the web page in a way similar to a user viewing the web page. In this way, an operator of the integrated management system is isolated from the communication details of each device and can concentrate on the type of management functions that the operator wants to perform.

Integrated Backup and Restore

In some embodiments, the integrated management system provides an integrated backup-and-restore facility that performs a backup or restore of the configuration data of multiple devices at once. For example, an integrated computer system may contain a server computer, a firewall, and a PBX. Backing up data is important for protecting information from loss due to device failure or for replicating backup information to other devices. An operator may also back up data during testing scenarios to store a particular known good configuration before performing potentially damaging operations. The integrated management system receives an instruction from an operator to perform a backup of the computer system. First, the integrated management system communicates with each device to gather configuration information for the device using the appropriate protocol for communicating with the device. Next, the integrated management system compiles the configuration information into a backup data format, such as a single file. Then, the integrated management system stores the backup data file on a storage device.

In some embodiments, the integrated management system stores backup data on a removable storage device. For example, an integrated computer system may provide ports for connecting removable devices, such as a universal serial bus (USB), Firewire, external serial advanced technology attachment (eSATA), or other port. An operator may attach a removable storage device, such as a USB flash drive, and instruct the integrated management system to perform a backup of the integrated computer system. When the backup is complete, the integrated management system stores the backup data on the removable storage device. In some environments in which an operator uses the integrated management system, the ability to remove data from the system quickly is important. For example, an operator may use the integrated management system in a battlefield environment in which soldiers may need to rapidly exit an area without leaving behind sensitive information. By storing information on removable storage devices, the integrated management system improves the ability to quickly leave with sensitive data.

In some embodiments, the integrated management system performs a backup of a subset of the devices of the integrated computer system. For example, the integrated management system may receive a selection of the devices to include in the backup from an operator. Alternatively or additionally, the integrated management system may group the devices of the integrated computer system by type or other grouping (e.g., firewalls) and may perform a backup of only certain groups. An operator may use this functionality before making a potentially harmful change, such as uploading new firewall firmware, to be able to return to a known good configuration.

In some embodiments, the integrated management system invokes an embedded backup facility for a device. For example, a device may provide a facility for generating a configuration file containing a backup of the configuration data of the device. The integrated management system invokes the embedded backup facility and receives the generated configuration file. For devices that do not provide an integrated backup facility, the integrated management system gathers operating parameters and other configuration data needed to restore proper operation of the device and places the gathered information in a format defined by the integrated management system for storing configuration data. The integrated management system may use a similar format for configuration data from devices that provide an integrated backup facility and for those that do not. For example, the integrated management system may use a format for configuration data that provides a header that describes the type of configuration data that follows the header.

In some embodiments, the integrated management system stores configuration data from each of the devices included in a backup operation in a single file. The file may contain a manifest that describes the contents of the file. For example, the manifest may describe each device for which configuration information is stored in the backup file. The manifest may include other information such as the time the integrated management system performed the backup, the operator that requested the backup, and a comment describing the backup.

In some embodiments, the integrated management system compresses backup data to save space. Backup data from many devices may become large, such that compressing the backup data significantly reduces the storage needed to store the backup data. For example, the integrated management system may store the backup data in a zip file or other compressed format to reduce the size of the backup data.

In some embodiments, the integrated management system encrypts backup data to limit access to the backup data. Backup data may contain sensitive information such as passwords, network topology, and other information that a malicious party could use to compromise the integrity of the computer system managed by the integrated management system. Therefore, the integrated management system may encrypt the backup data using an encryption scheme, such as the advanced encryption standard (AES). The integrated management system may request that the operator enter a passphrase during backup that integrated management system uses to encrypt the backup data. When an operator attempts to restore the backup data, the integrated management system requests that the operator enter the passphrase, and only continues with the restore if the operator enters the correct passphrase. Alternatively or additionally, the integrated management system may use a stored encryption key, such as on a removable storage device. If an operator does not possess the stored encryption key, the operator will be unable to restore the backup data.

In some embodiments, the integrated management system receives notification when an operator attaches new devices to a computer system. For example, in one integrated computer system described above, an operator can add new devices to the computer system by sliding in new trays to a tray-receiving rack. When an operator attaches a new device to the computer system, the integrated management system receives notification indicating the type and other information about the new device. Thus, the integrated management system includes configuration for new devices in future backup operations.

In some embodiments, the integrated management system restores backup data to a different computer system than the one from which the backup data was gathered. For example, an operator may use the backup data to clone the configuration of one system to another system, such as when many identical computer systems are needed. In some embodiments, the integrated management system may modify the backup data when applying the backup data to a different system based on information unique to the different system. For example, if the computer system is a Windows Domain Controller (DC), each DC may contain unique keys and user identifiers that the integrated management system modifies in the backup data to produce a computer system configured similarly, although not identically, to the system from which the backup data was taken.

In some embodiments, the integrated management system restores a subset of the devices for which configuration information is stored in the backup data. For example, the integrated management system may allow an operator to select which devices the operator wants to restore. Restoring configuration data can take a substantial amount of time and the operator may want to limit the restore to devices that the operator knows are not function correctly, while leaving devices that the operator knows are functioning correctly alone.

In some embodiments, the integrated management system contains backup data that describes the configuration of the system when a manufacturer built the system. An operator can use this backup data to restore the integrated management system to a factory-default configuration. Such a configuration may be useful if the state of a particular system is unknown and the operator wants to return the system to a known good state.

In some embodiments, the integrated management system restores devices in a specific order based on device requirements. For example, some devices may need to be restored before other devices, while other devices may need to be restored last. A network switch, for example, may need to be operational for the integrated management system to communicate with each of the other devices, so the integrated management system may restore the configuration of the network switch last to leave the network switch in a current operation state. In contrast, some devices, such as a firewall, may need to receive a valid password before the integrated management system can access other devices through them. Thus, the integrated management system may restore such devices before other devices.

In some embodiments, the integrated management system restores devices in parallel. Some devices do not depend on other devices or can be grouped such that no devices in the group depend on one another. In such cases, the integrated management system may restore each of the devices in the group at the same time to reduce the time to complete the overall restore operation. A restore operation of many devices can take a significant amount of time such that by restoring devices in parallel the integrated management system saves an operator a significant amount of time.

In some embodiments, the integrated management system provides an alternative interface for accessing a device. Sometimes during restoring a device, a device may be placed in an inaccessible state. For example, an operator may specify an incorrect IP address for a network device or the operator may forget the IP address selected for the network device, such that the operator cannot access the device through the network. Thus, the integrated management system may provide an alternative interface, such as a serial port, that the integrated management system can use to access the device when the primary interface is unavailable. The integrated management system may use the alternative interface to reset the device to a known factory state or to set configuration parameters that will allow the operator to regain access to the device through the primary interface.

In some embodiments, the integrated management system restarts devices after restoring. For example, some devices may need to be restarted before configuration changes take effect. The integrated management system may also reset certain devices before restoring other devices. For example, the integrated management system may restore the configuration of a network switch and then restart the network switch before restoring other devices so that the other devices are accessible through the network switch.

In some embodiments, the integrated management system notifies an administrator when an operator is performing a restore operation. A restore operation that is performed incorrectly may leave the system in an inaccessible state or may make the system unavailable for a certain period while the restore operation completes. Therefore, a system administrator may request that the integrated management system inform the system administrator when an operator is performing a restore operation. Thus, the integrated management system may send a notification, such as an email, to a system administrator when an operator initiates a restore operation.

Integrated Device Configuration

In some embodiments, the integrated management system performs configuration of multiple devices from a single user interface. For example, the integrated management system may provide a user interface for setting IP addresses for multiple devices in one place. An operator may use the integrated management system to set IP addresses for a network switch, server, firewall, PBX, and other components. Setting the IP address of these types of components is a typically error-prone process. However, using the integrated management system the chance for error is reduced by allowing the operator to view and change the IP address for each device in one place. Similarly, the integrated management system may allow an operator to set passwords for multiple devices at once. Many devices in an integrated computer system have passwords for performing administrative tasks or for accessing sensitive data. By allowing the operator to set these passwords in one place, the integrated management system increases the consistency of the system. For example, an operator may apply the same password to all of the devices in the system, or to all devices of a particular type in the system.

In some embodiments, the integrated management system provides a peering wizard for establishing a shared data connection between two integrated computer systems. Integrated computer systems may want to share data in many situations. For example, one integrated computers system may be located locally while another is out in the field near a particular source of data. Likewise, a PBX attached to one computer system may have access to phone handsets that another computer system would like to access. An Ethernet or other network may attach the integrated computer systems. The peering wizard requests information from an operator needed to establish a connection between the two integrated computer systems. For example, the wizard running on one system may request the IP address of the second system. The wizard may also request information needed to access and modify the firewall of the second system to allow network traffic from the first system, such as the address of the untrusted interface of the firewall and a network key used to authenticate with the firewall. Next, the wizard sets up a virtual private network (VPN) between the two systems over the network that connects them. A VPN allows secure traffic to be sent over an unsecure link. Thus, the two systems can communicate and share data without fear of the data being intercepted and compromised.

In some embodiments, the integrated management system transmits data, voice, or video (e.g., phone calls) to another similar system by peering the two systems. For example, a phone call from a first integrated computer system may be converted into voice data and sent over IP to a second integrated computer system. Upon receiving the voice data, the second integrated computer system can convert the voice data back into phone call data and forward the phone call to a handset attached to a PBX connected to the second integrated computer system or over a public-switched telephone network (PSTN). The integrated management system may peer two systems by establishing a VPN and/or a Windows Trust between the two systems or by using other peering technologies. These technologies may provide a secure channel for exchanging data between the two systems and provide failover or other fault tolerant benefits. The integrated management system may also provide a wizard for peering two systems that collects information from an operator or fills in certain values without user input to make the process of peering easier. Thus, peering extends the abilities of one integrated computing system by providing users or devices of the integrated computing system with access to additional computer systems and data.

Integrated Device Monitoring

In some embodiments, the integrated management system provides a unified display of system status information. Each device managed by the system may have a health indicated by simple indicators (such as a red, yellow, or green light). Periodically, the system requests the status of each device. If a device fails to respond or indicates that there is a problem causing the device to be unavailable, then the integrated management system indicates that the device is not functioning correctly. The integrated management system may also gather information about a device from existing information sources such as the Windows Event Log. By gathering status information into a unified interface, the integrated management system makes it easy for an operator to determine which devices are functioning correctly versus which devices may be the cause of problems reported to the operator.

Figures

The following description illustrates details of the integrated management system described above with reference to the figures. The figures are provided only to demonstrate example embodiments of the system and those of ordinary skill in the art will appreciate that many other embodiments of the above-described details can be achieved.

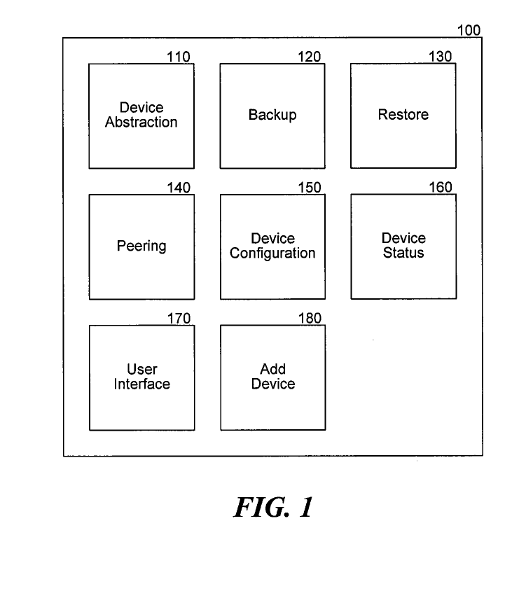

FIG. 1 is a block diagram that illustrates components of the integrated management system in one embodiment. The integrated management system 100 contains a device abstraction component 110, a backup component 120, a restore component 130, a peering component 140, a device configuration component 150, a device status component 160, a user interface component 170, and an add device component 180. The device abstraction component 110 allows the integrated management system 100 to communicate with many different devices from many different vendors. For example, the device abstraction component 110 may understand many protocols for communicating with devices such as SNMP, Telnet, SOAP, and so on. The device abstraction component 110 may also understand proprietary protocols or implementation differences specific to a particular vendor or device. The backup component 120 performs an integrated backup of configuration data for all of the devices managed by the integrated management system 100. The backup component 120 may produce a single file backup that an operator can use to restore a set of devices or to clone the configuration of one set of devices to another set of devices. The restore component 130 performs an integrated restore of configuration data for all of the devices managed by the integrated management system 100. The restore component 130 receives the file created by the backup component 130 and restores the configuration data contained in the file to each of the devices. Both the backup component 120 and the restore component 130 may operate on a subset of devices based on a selection received from an operator.

The peering component 140 creates peer connections between integrated computer systems for sharing data between the systems. For example, the peering component 140 may create a VPN between two integrated computer systems that allows phone calls and other data to pass between the systems. The device configuration component 150 provides unified configuration of multiple devices. For example, the device configuration component 150 may allow an operator to set IP addresses or passwords for all of the devices in an integrated computer system from a single user interface. The device status component 160 monitors the status of each device and provides a status indication of the health of the device. For example, if a device is malfunctioning, then the device status component 160 will report the malfunction to an operator through the device status component 160. The user interface component 170 provides an interface through which the integrated management system 100 provides information to an operator and receives input from the operator. The add device component 180 monitors the devices attached to an integrated computer system and provides notification to the integrated management system 100 when a device is added or removed from the system. The add device component 180 may also report the initial devices attached to the system when the system is powered on.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

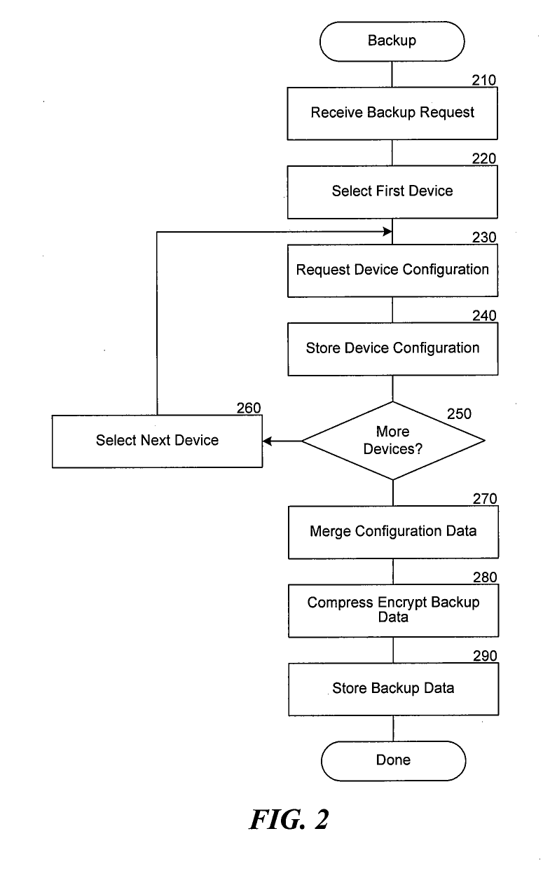

FIG. 2 is a flow diagram that illustrates the processing of the backup component of the integrated management system in one embodiment. The component is invoked when an operator requests a backup operation. In block 210, the component receives a backup request from an operator. The backup request may contain information such as the devices to include in the backup, a passphrase to use to encrypt the backup data, a comment from the operator, and so on. In block 220, the component selects the first device to be backed up. In block 230, the component requests the configuration data for the selected device. The configuration data may be a file that the device provides, or the component may request configuration parameters individually from the device. In block 240, the component stores the configuration data in a temporary location. In decision block 250, if there are more devices then the component continues at block 260, else the component continues at block 270. In block 260, the component selects the next device and then loops to block 230 to request the configuration of the device. In block 270, the component merges the configuration data of each device into a single backup data format, such as a single file. In block 280, the component performs any post-processing on the backup data, such as compressing or encrypting the backup data. In block 290, the component stores the backup data to a location requested by the operator. For example, the component may store the backup data to a removable USB drive or other storage device. After block 290, the component completes.

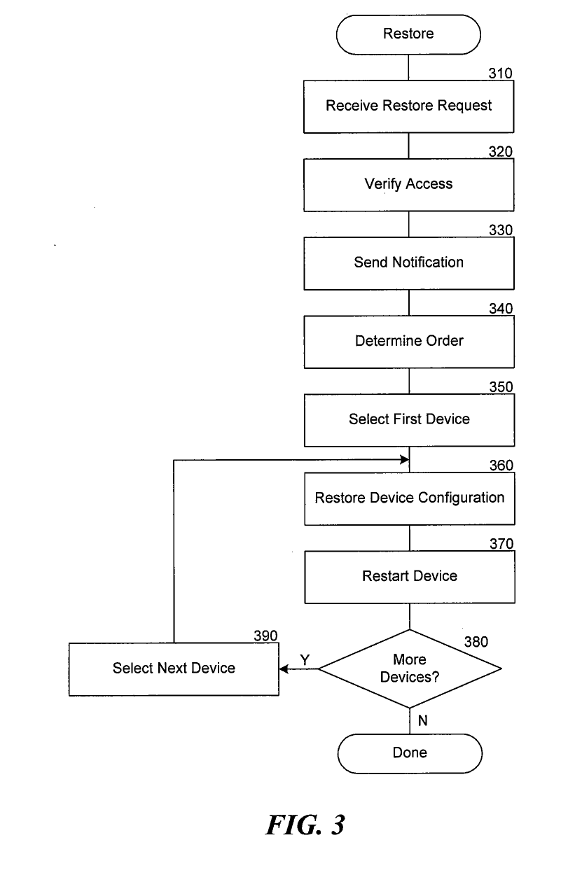

FIG. 3 is a flow diagram that illustrates the processing of the restore component of the integrated management system in one embodiment. The component is invoked when an operator requests a restore operation. In block 310, the component receives a restore request from an operator. The restore request may contain information such as the backup data to restore, a passphrase to use to decrypt the backup data, devices to include in the restore, and so on. In step 320, the component verifies the operator's access to perform the restore operation, such as be verifying the passphrase provided by the operator. If the verification fails, then the component may abort the restore operation and complete (not shown). In block 330, the component sends a notification, such as to a system administrator, that a restore operation is being performed. In block 340, the component determines the order in which the devices will be restored, based on any dependencies between the devices. For example, a first device may depend on a second device being operational, so the first device may be restored before the second device. In block 350, the component selects the first device to be restored. In block 360, the component restores the configuration data of the selected device. In block 370, the component may restart the device if necessary for the device to load the restored configuration data. Alternatively, the component may wait until the configuration data for some or all of the devices is restored before restarting one or more devices. In decision block 380, if there are more devices, then the component continues at block 390, else the component completes. In block 390, the component selects the next device, and then loops to block 360 to restore the configuration of the device.

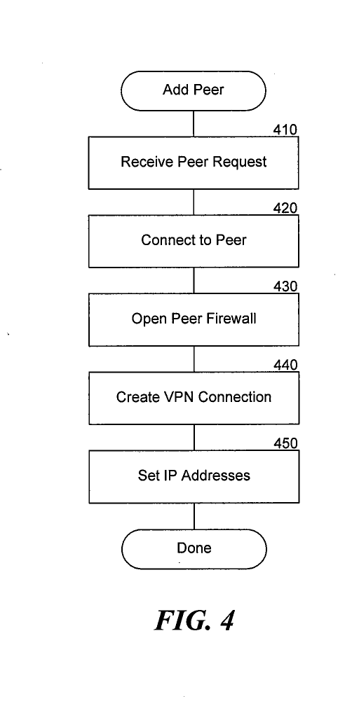

FIG. 4 is a flow diagram that illustrates the processing of the peering component of the integrated management system in one embodiment. The component is invoked when an operator attempts to establish a peer relationship between two integrated computer systems. In block 410, the component receives a request to add a peer from an operator. The request may include information such as the IP address of the peer system, a network key for accessing the peer system's firewall, and so on. In block 420, the component connects to the peer system. In block 430, the component opens the firewall of the peer system. For example, the component may need to open particular ports on the firewall to allow the component to make a connection to the peer system. In block 440, the component creates a VPN connection with the peer system that allows the integrated management system to send secured data to the peer system over a standard unsecured network connection. In block 450, the component sets up IP addresses for accessing data on each system from the other system. After block 450, these steps conclude.

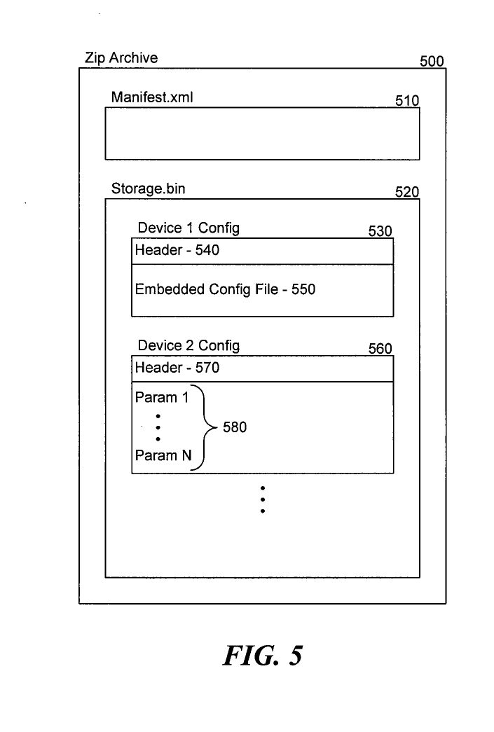

FIG. 5 is a data structure that illustrates the format for storing backup data from multiple devices in one embodiment. The data structure 500 may be embodied in a single file, such as a compressed zip archive. The data structure 500 contains a manifest 510 named manifest.xml and a backup data file 520 named storage.bin. The manifest 510 describes the data stored in the backup data file 520. The manifest may be in a format such as extensible markup language (XML) for easy categorization of data. The manifest may indicate the devices that have configuration data stored in the data structure 500 and the time when the configuration data was stored. The backup data file 520 contains configuration data for each backed up device. The backup data file 520 contains configuration data 530 for a first device. The configuration data 530 contains a header 540 that describes the type of backup data and an embedded configuration file 550 provided by the device. The backup data file 520 also contains configuration data 560 for a second device. The configuration data 560 contains a header 570 that describes the type of backup data and a list 580 of stored configuration parameters. The list of parameters may be used when the device does not provide a method of exporting configuration data to a file. The data structure 500 may contain backup data for many devices, and can be stored on a storage device, such as a USB flash drive.

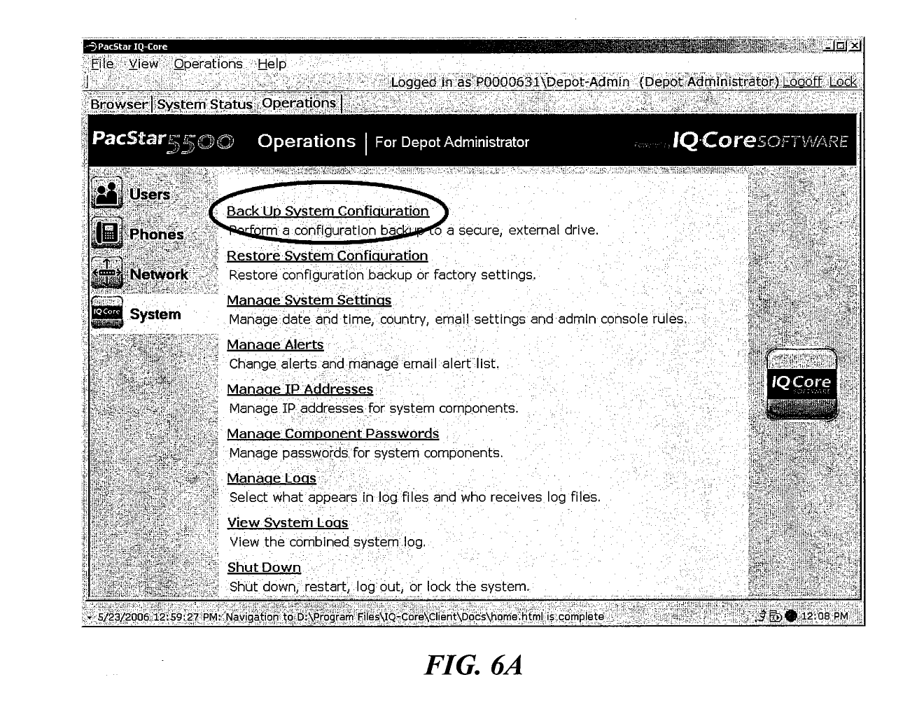

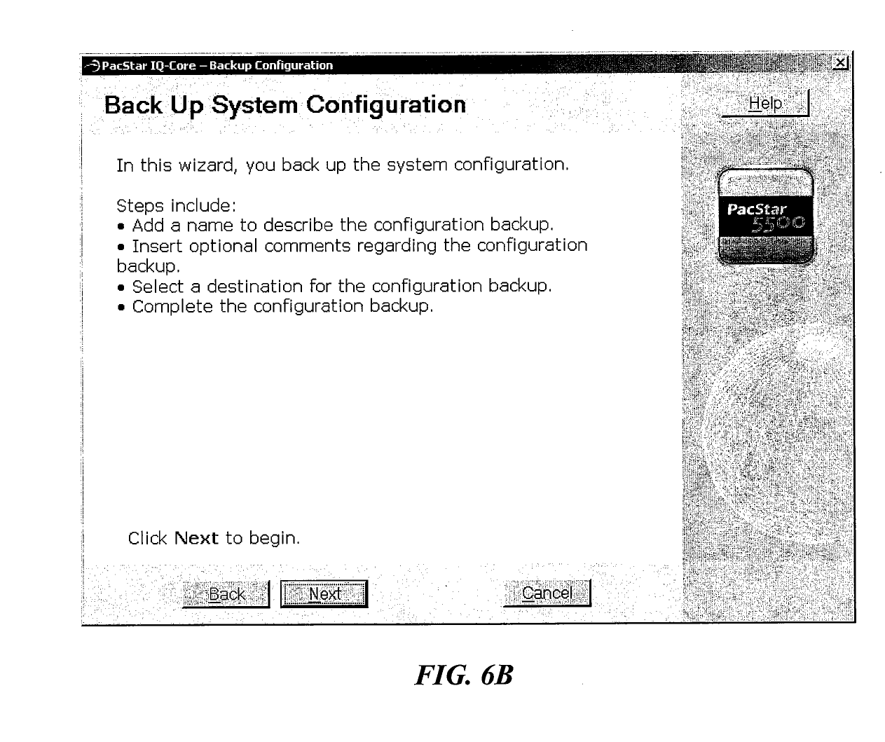

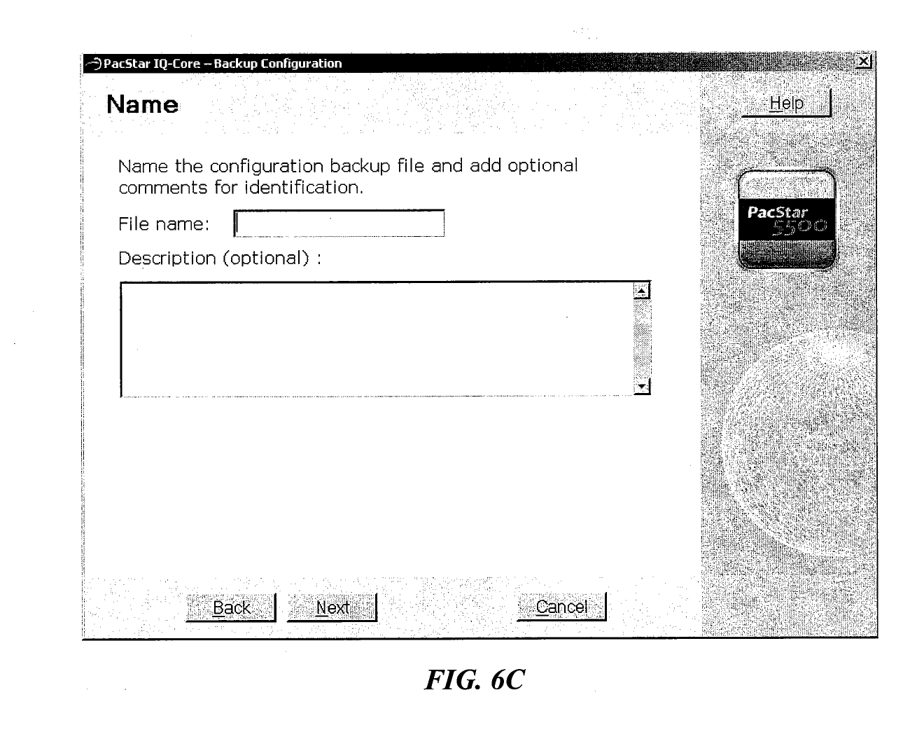

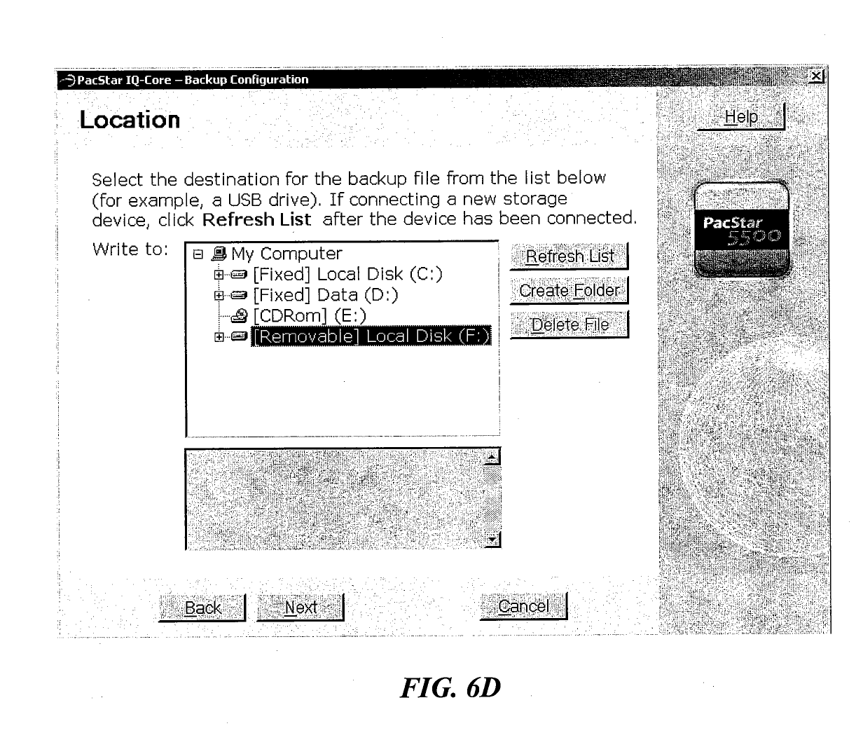

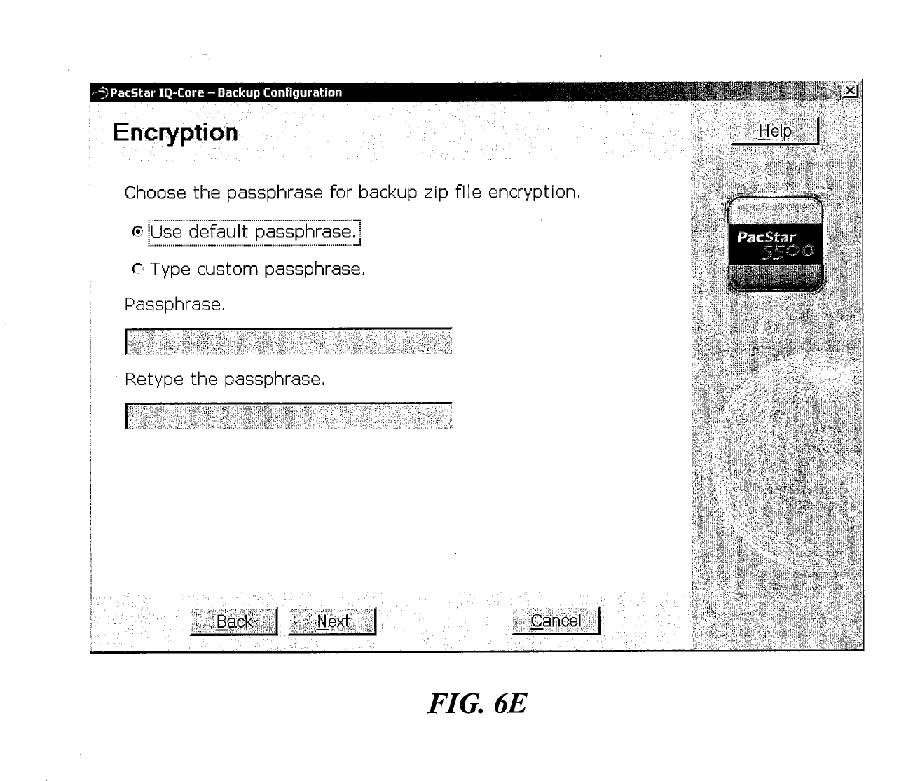

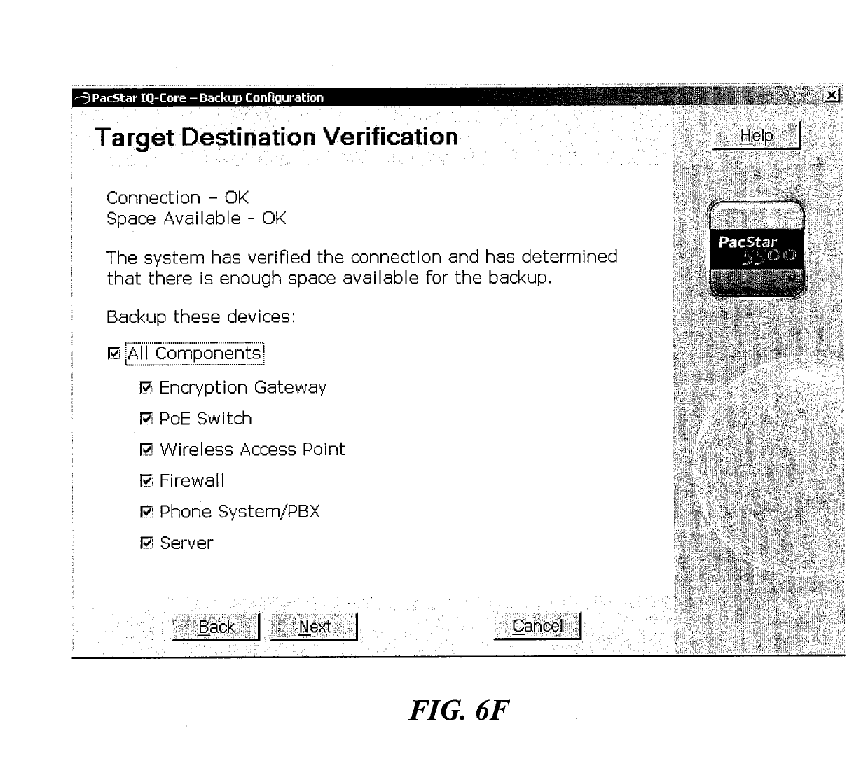

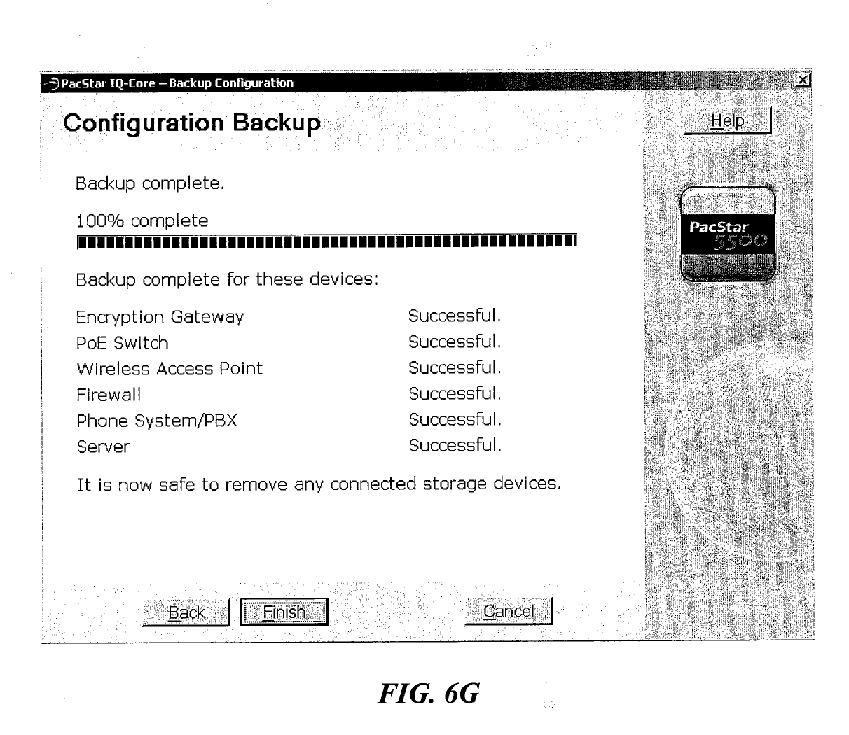

FIGS. 6A-6G illustrate display pages of the user interface of the system for backing up the configuration of multiple devices in one embodiment. FIG. 6A illustrates the main screen of a user interface from which the operator can select a variety of configuration options that affect multiple devices, including a backup operation. FIG. 6B illustrates an introductory display page that describes the backup operation. FIG. 6C receives information about the backup from the operator, such as a name for the backup file and a description of the backup data. FIG. 6D receives a location to store the backup data from the operator. FIG. 6E allows the operator to add a passphrase with which to encrypt the backup data. FIG. 6F receives a selection from the operator of which devices in the system are to be included in the backup. FIG. 6G displays the progress of the backup operation to the operator and indicates whether the backup of each device was successful.

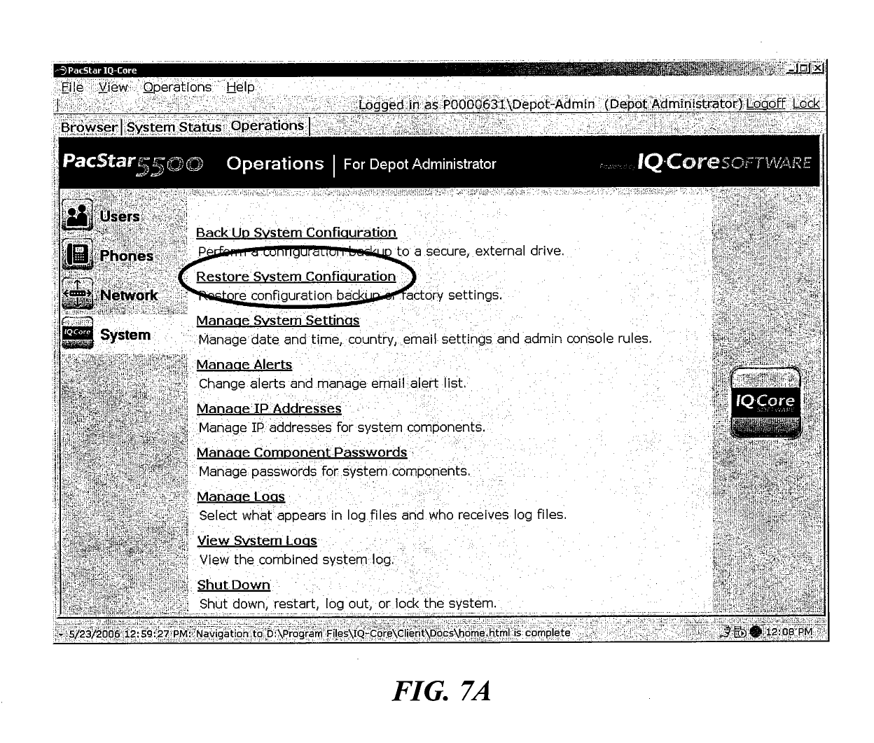

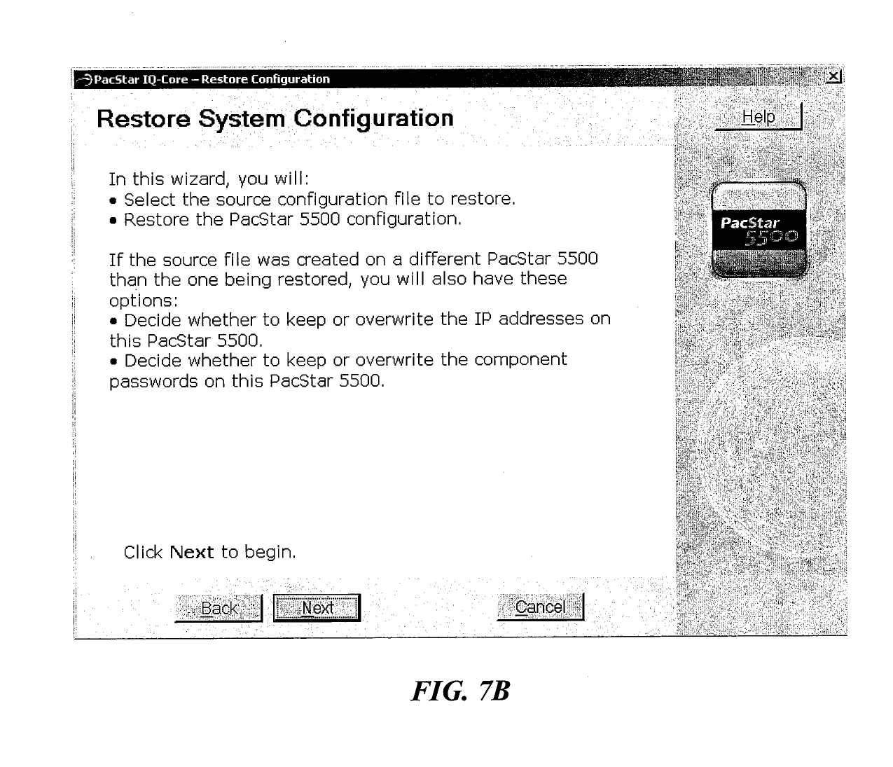

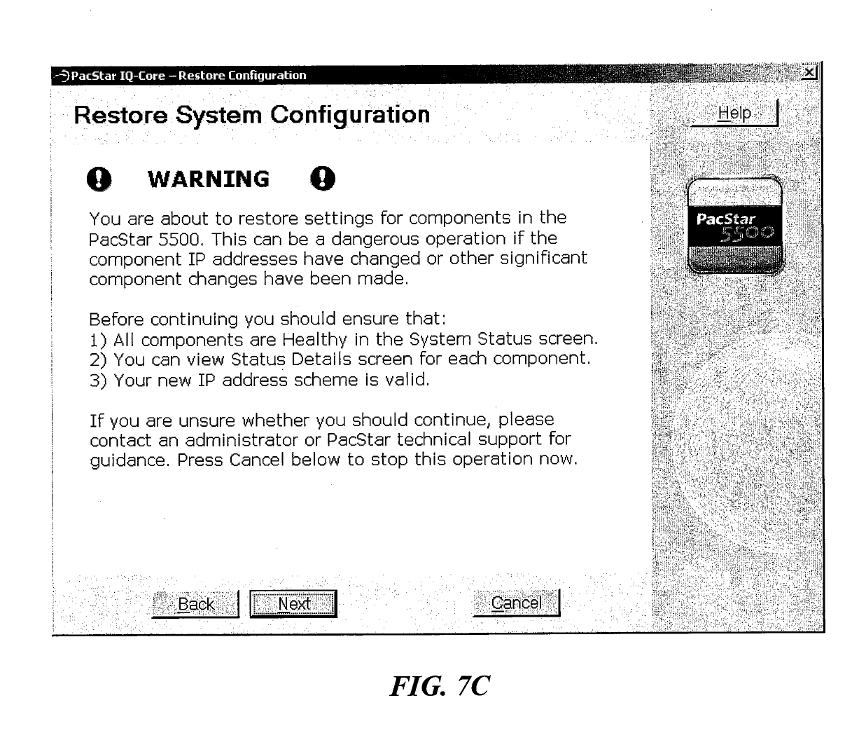

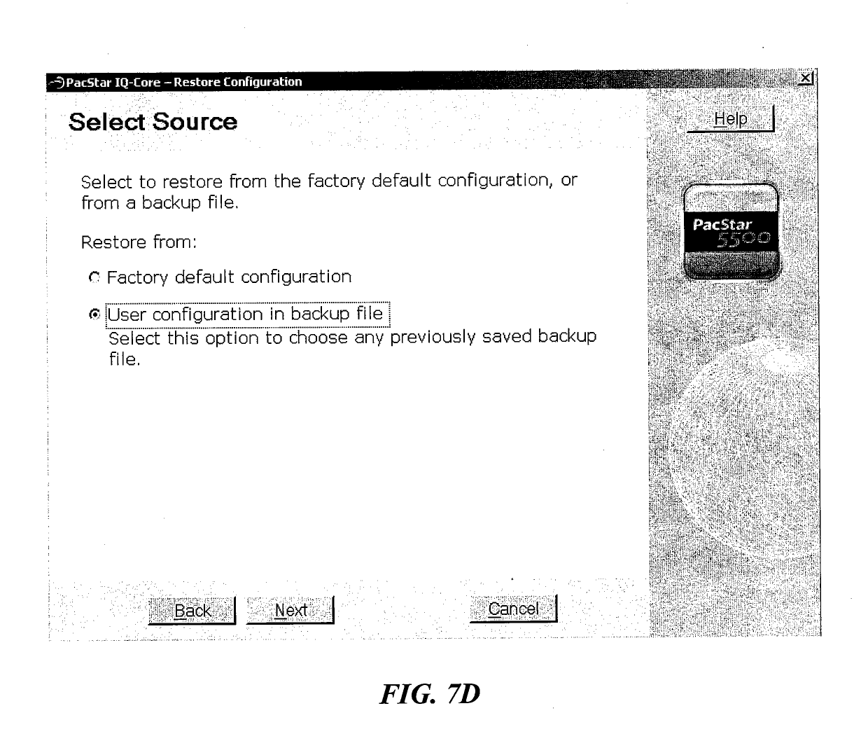

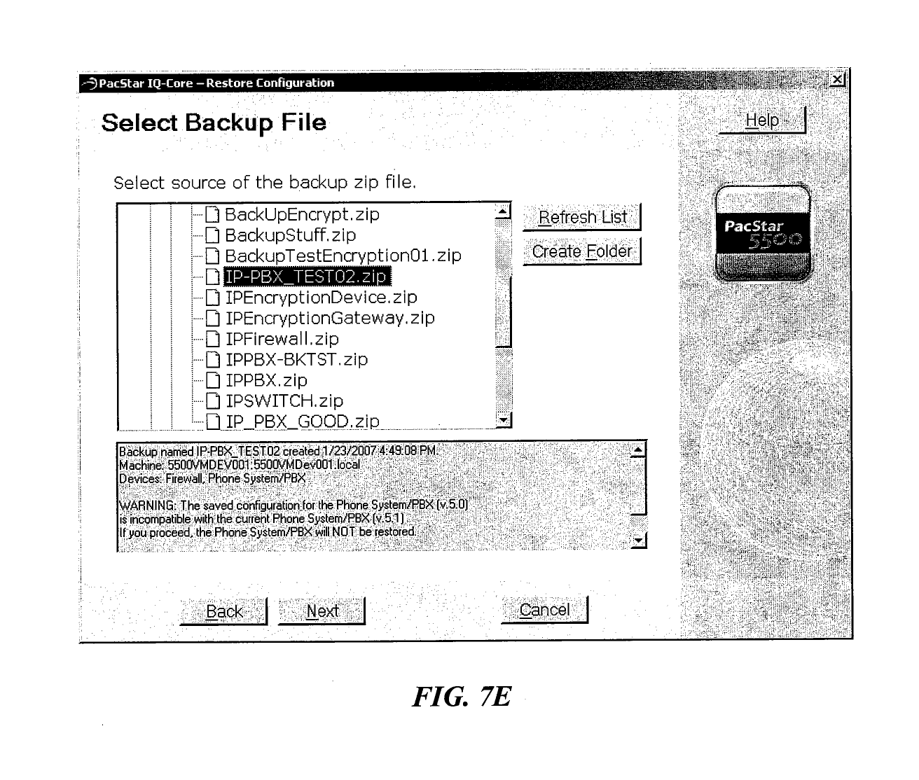

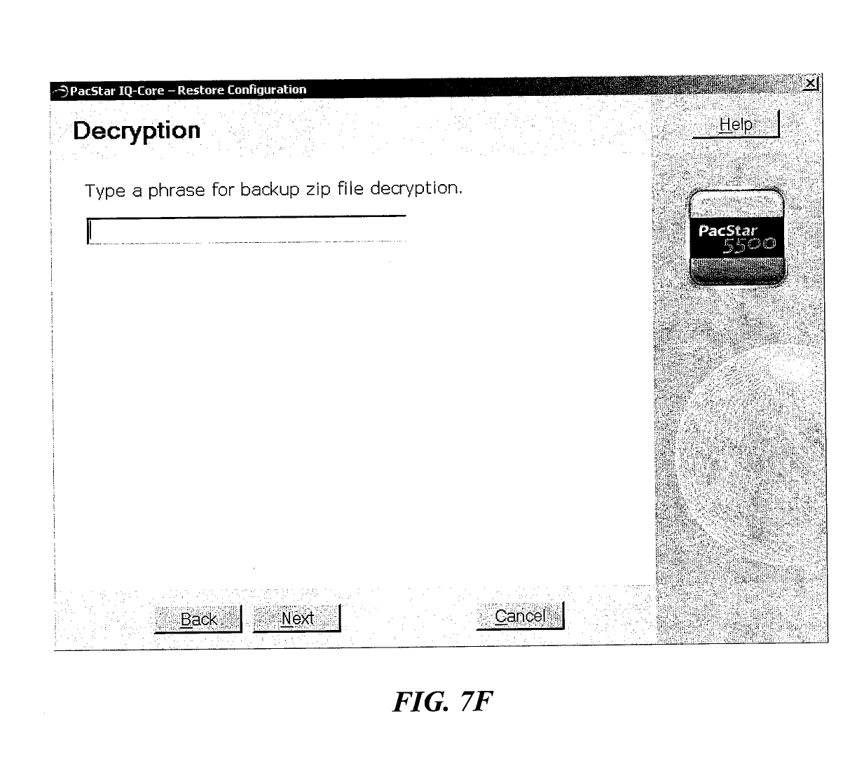

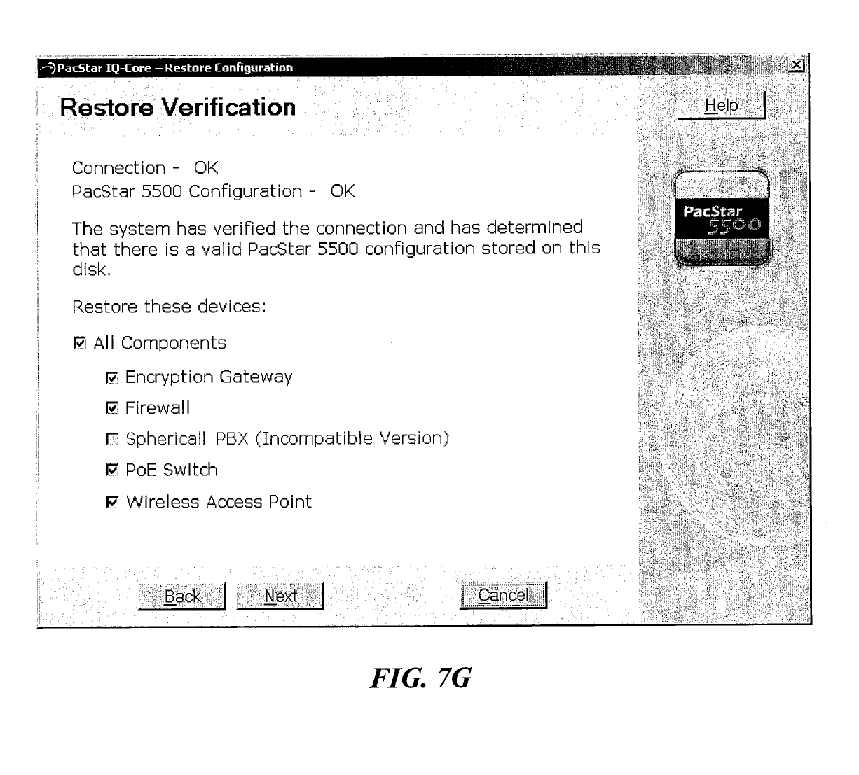

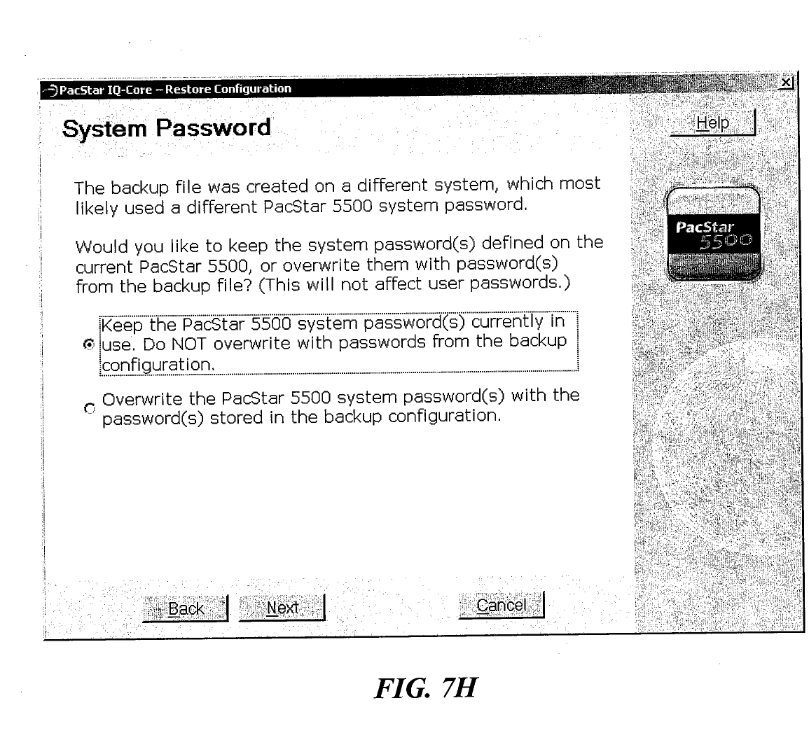

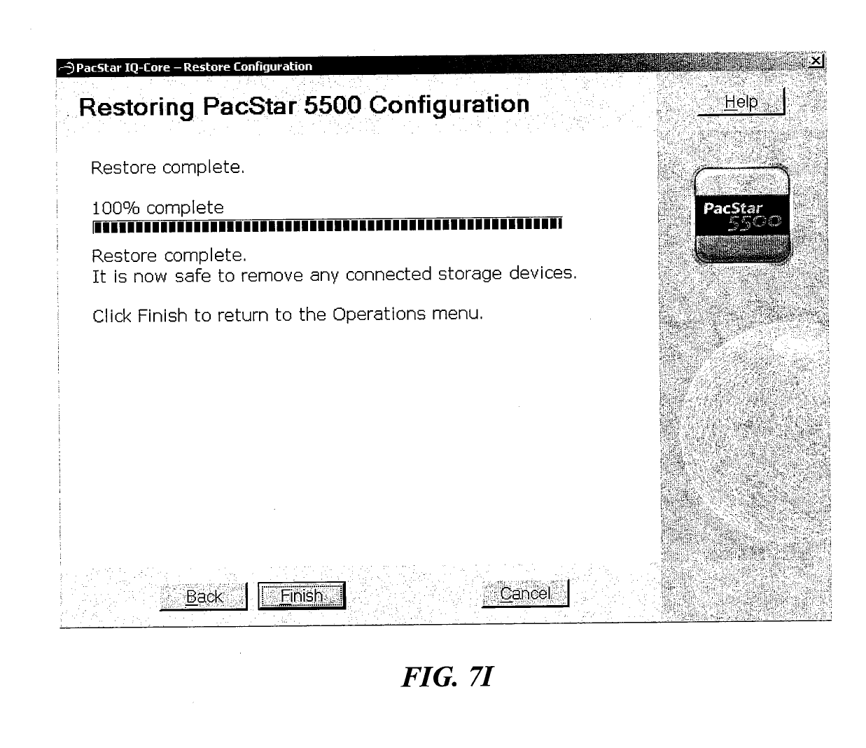

FIGS. 7A-7I illustrate display pages of the user interface of the system for restoring up the configuration of multiple devices in one embodiment. FIG. 7A illustrates the main screen of a user interface from which the operator can select a variety of configuration options that affect multiple devices, including a restore operation. FIG. 7B illustrates an introductory display page that describes the restore operation, such as the information that the system will request from the operator. FIG. 7C provides a warning to the operator indicating that the restore operation is potentially destructive to the existing configuration. FIG. 7D receives a selection from the operator indicating which backup data the system should restore. The operator may provide a path to a particular backup file or may request that the system restore itself to a factory state. FIG. 7E allows the operator to navigate to a stored backup file, and displays information about a selected backup file. FIG. 7F receives a passphrase from the operator that the system will use to decrypt the backup data. FIG. 7G receives a selection from the operator indicating which devices stored in the backup data the system should restore. FIG. 7H illustrates a warning to the operator indicating that a restore of backup data from one system to a different system is potentially destructive, and verifies that the operator wants to perform the operation. FIG. 7I displays the progress of the restore operation and indicates whether the restore of each device was successful.

### CONCLUSION

From the foregoing, it will be appreciated that specific embodiments of the integrated management system have been described herein for purposes of illustration, but that various modifications may be made without deviating from the spirit and scope of the invention. Although several environments have been described, the integrated management system can be used in many environments. For example, the integrated management system may be used in an integrated computer system built to provide a rapidly deployable network to situations like a battlefield or disaster relief area. The integrated management system may also be used in offices to provide management of multiple devices and computer systems. As the complexity of home networks increase, the integrated management system can be used to provide management of multiple devices from one location. Accordingly, the invention is not limited except as by the appended claims.

I/We claim:

1. A method in a computer system for backing up the configuration of multiple devices, the method comprising:
receiving from a user a selection of devices to backup;
for each selected device, requesting the configuration data from the device without requesting additional information from the user;
combining the configuration data from each device to create backup data;
storing the backup data on a storage device.

2. The method of claim 1 including receiving an encryption key from the user and encrypting the backup data.

3. The method of claim 2 wherein the encryption key is a passphrase.

4. The method of claim 1 including compressing the backup data.

5. The method of claim 1 including restoring the backup data to the computer system.

6. The method of claim 1 including restoring the backup data to a different computer system.

7. The method of claim 1 wherein at least one device is located at a location remote from the computer system.

8. The method of claim 1 wherein at least one device is manufactured by a different vendor than at least one other device.

9. The method of claim 1 wherein the system accesses the devices through a device abstraction layer.

10. The method of claim 1 wherein requesting the configuration data from the device comprises requesting the configuration data through a protocol selected from the group consisting of WMI, TCP, COM, SNMP, Telnet, SSH, SOAP, and FTP.

11. The method of claim 1 wherein the devices are selected from the group consisting of a server, firewall, switch, wireless access point, and PBX.

12. The method of claim 1 wherein the storage device is a removable storage device.

13. The method of claim 1 wherein requesting the configuration data from the device comprises invoking an backup facility provided by the device.

14. A computer system for managing the configuration of multiple peripherals, comprising:
a backup component configured to request configuration data from each peripheral and combine the configuration data from each peripheral to create backup data;
a device abstraction component configured to communicate with each peripheral through a management interface exposed by the peripheral; and
a device status component configured to monitor the health of each peripheral.

15. The system of claim 14 wherein the management interface is selected from the group consisting of WMI, TCP, SNMP, Telnet, SSH, SOAP, and FTP.

16. The system of claim 14 wherein the device abstraction component is further configured to communicated with each peripheral through an alternative management interface if a primary management interface is unavailable.

17. The system of claim 14 wherein the backup component is further configured to store the backup data on a removable storage device.

18. A computer-readable medium encoded with instructions for controlling a computer system to create a peer relationship between two computer systems, by a method comprising:
requesting information from an operator at a first system for accessing a second system, wherein the second system comprises a server and a firewall device;
configuring the firewall of the second system to accept data from the first system;
creating a secured connection between the first and second systems through the firewall;
sharing data between the first and second system over the secured connection.

19. The computer-readable medium of claim 18 wherein requesting information from an operator at a first system comprises requesting an IP address and network key from the operator.

20. The computer-readable medium of claim 18 wherein sharing data comprises sending phone call information from the first system to the second system.
